(19) United States
(12) Patent Application Publication
(10) Pub. No.: US 2017/0329858 A1
(43) Pub. Date: Nov. 16, 2017

(54) SYSTEM AND METHOD FOR ENHANCED USER MATCHING BASED ON MULTIPLE DATA SOURCES

(71) Applicants: James Joseph Adamy, Los Angeles, CA (US); Gustavo Marin, Blaine, WA (US)

(72) Inventors: James Joseph Adamy, Los Angeles, CA (US); Gustavo Marin, Blaine, WA (US)

(21) Appl. No.: 15/665,420

(22) Filed: Jul. 31, 2017

Related U.S. Application Data
(63) Continuation of application No. 15/296,020, filed on Oct. 17, 2016.
(60) Provisional application No. 62/243,123, filed on Oct. 18, 2015.

(51) Int. Cl. G06F 17/30

(52) U.S. Cl. CPC G06F 17/30867; G06F 17/3053

(57) ABSTRACT

A system for enhanced user matching utilizing multiple data sources, comprising a profile module that receives a plurality of user profile information and produces a plurality of profile data values based on the profile information, a scoring module that produces a plurality of scoring values based on associated profile data values, and a matching engine that produces a plurality of profile matches based on the plurality of profile data values, and a method for enhanced user matching.

### CROSS-REFERENCE TO RELATED APPLICATIONS

This application is a continuation of U.S. patent application Ser. No. 15/296,020, titled “SYSTEM AND METHOD FOR ENHANCED USER MATCHING BASED ON MULTIPLE DATA SOURCES” and filed on Oct. 17, 2016, which claims the benefit of, and priority to, U.S. provisional patent application 62/243,123, titled, “SYSTEM AND METHOD FOR ENHANCED USER MATCHING BASED ON MULTIPLE DATA SOURCES”, and filed on Oct. 18, 2015, the entire specifications of which are incorporated herein by reference in their entirety.

### BACKGROUND OF THE INVENTION

### Field of the Art

The disclosure relates to the field of interactively matching users, institutions, establishments, and projects.

### Discussion of the State of the Art

According to a Gallup poll, 63% of global workers are not ‘engaged’ (lack motivation) and 24% are ‘actively disengaged’ (unhappy or unproductive) at work, leaving only 13% that are happy and motivated. 30 million millennials are out of work and have accumulated over $1 trillion in student debt, and 20 million “Gen Xers” have stalled in their careers and lost 45% of their net worth. 75% of Gen Y employees want mentors, and 77% of Generation Y have smartphones and use them to obtain needed information. Ignoring generational influences and look at a breakdown of the US workforce, it's clear there are large sectors full of workers affected by career stagnation and a lack of online or offline resources that provide tailored strategies and tactics to leap ahead in this ever changing economy.

What is needed is a means to utilize available data sources and commonly-utilized smartphone devices to perform enhanced user matching to aid professionals in making career and business choices and overcoming challenges.

### SUMMARY OF THE INVENTION

Accordingly, the inventor has conceived and reduced to practice, in a preferred embodiment of the invention, a system and method for enhanced user matching utilizing multiple data sources.

According to a preferred embodiment of the invention, a system for enhanced user matching utilizing multiple data sources, comprising a profile module comprising a plurality of programming instructions stored in a memory and operating on a processor of a computing device, and configured to receive a plurality of profile data that may be associated with at least a plurality of human users, and configured to produce at least a plurality of profile data values, the profile data values being based at least in part on at least a portion of the plurality of profile data; a scoring engine comprising a plurality of programming instructions stored in a memory and operating on a processor of a computing device, and configured to receive at least a plurality of profile data values, and configured to produce at least a plurality of scoring values based at least in part on at least a portion of the plurality of profile data values; and a matching engine comprising a plurality of programming instructions stored in a memory and operating on a processor of a computing device, and configured to receive at least a plurality of scoring values and configured to produce at least a plurality of profile matches, the profile matches being based at least in part on at least a portion of the plurality of scoring values, is disclosed.

According to another preferred embodiment of the invention, a method for enhanced user matching utilizing multiple data sources, comprising the steps of receiving, at a profile module comprising a plurality of programming instructions stored in a memory and operating on a processor of a computing device, and configured to receive a plurality of profile data that may be associated with at least a plurality of human users, and configured to produce at least a plurality of profile data values, the profile data values being based at least in part on at least a portion of the plurality of profile data, a plurality of user profile information; producing at least a plurality of profile data values, the profile data values being based at least in part on at least a portion of the plurality of user profile information; providing at least a portion of the plurality of profile data values as data output; receiving, at a scoring engine comprising a plurality of programming instructions stored in a memory and operating on a processor of a computing device, and configured to receive at least a plurality of profile data values, and configured to produce at least a plurality of scoring values based at least in part on at least a portion of the plurality of profile data values, a plurality of profile data values; producing at least a plurality of scoring values, the scoring values being based at least in part on at least a portion of the plurality of profile data values; receiving, at a matching engine comprising a plurality of programming instructions stored in a memory and operating on a processor of a computing device, and configured to receive at least a plurality of scoring values and configured to produce at least a plurality of profile matches, the profile matches being based at least in part on at least a portion of the plurality of scoring values, at least a plurality of profile data value; producing at least a plurality of profile matches, the profile matches being based at least in part on at least a portion of the plurality of profile data values; and presenting at least a portion of the profile matches to a user for review, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for enhanced user matching, according to a preferred embodiment of the invention.

FIG. 6 is a flow diagram illustrating an exemplary method for enhanced user matching, according to a preferred embodiment of the invention.

FIG. 7 is a block diagram illustrating a more detailed view of a scoring engine and scoring logic.

FIG. 8 is a block diagram illustrating a more detailed view of a matching engine and matching logic.

FIG. 9 is an illustration of an exemplary user interface for a mobile application operating on a smartphone, illustrating a preliminary user configuration and a home screen overview.

FIG. 10 is an exemplary flow diagram illustrating a method for overriding calculated elements with profile elements according to a preferred embodiment of the invention.

### DETAILED DESCRIPTION

The inventor has conceived, and reduced to practice, a system and method for enhanced user matching utilizing multiple data sources.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

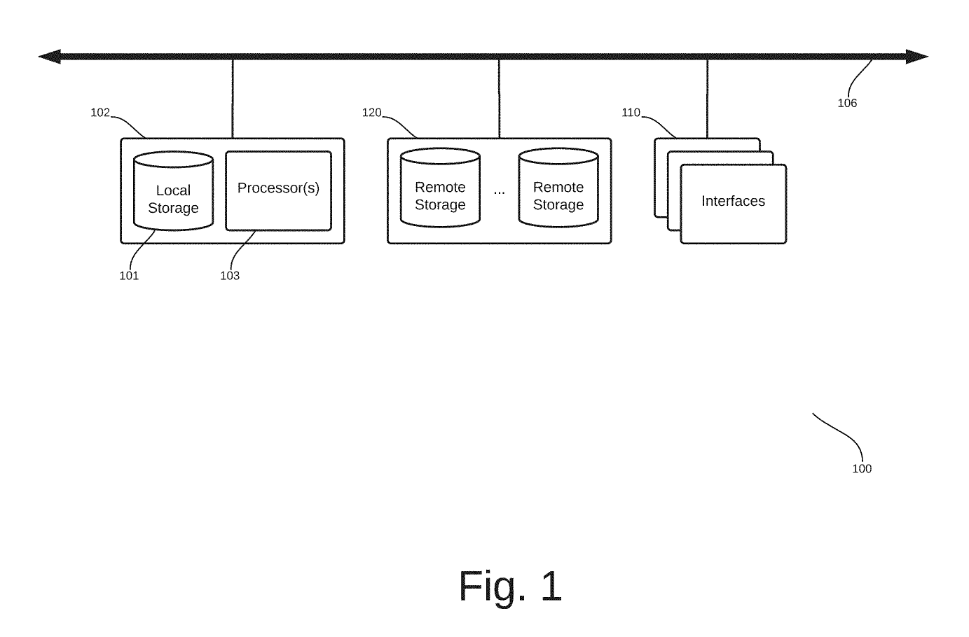

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

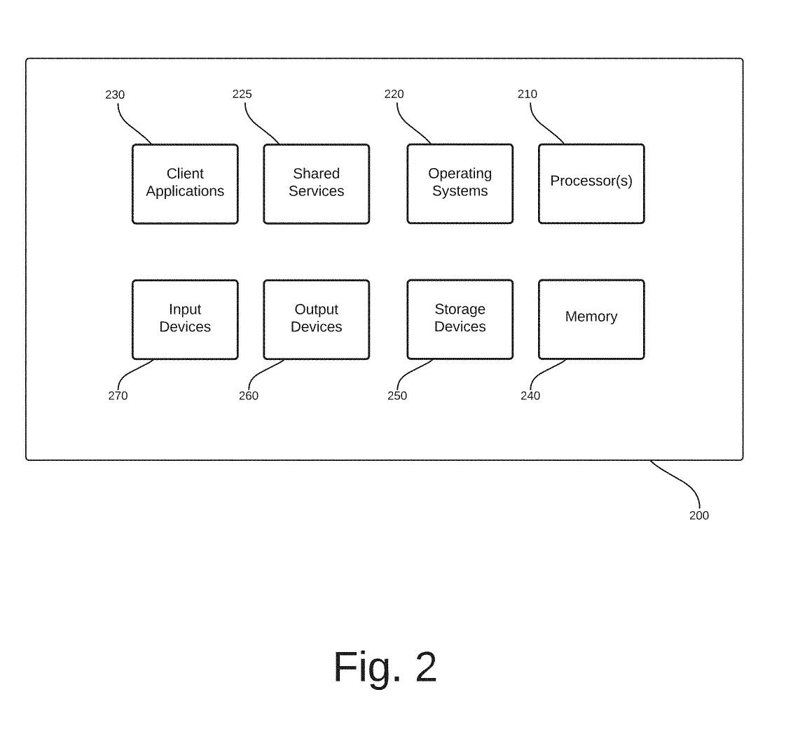

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

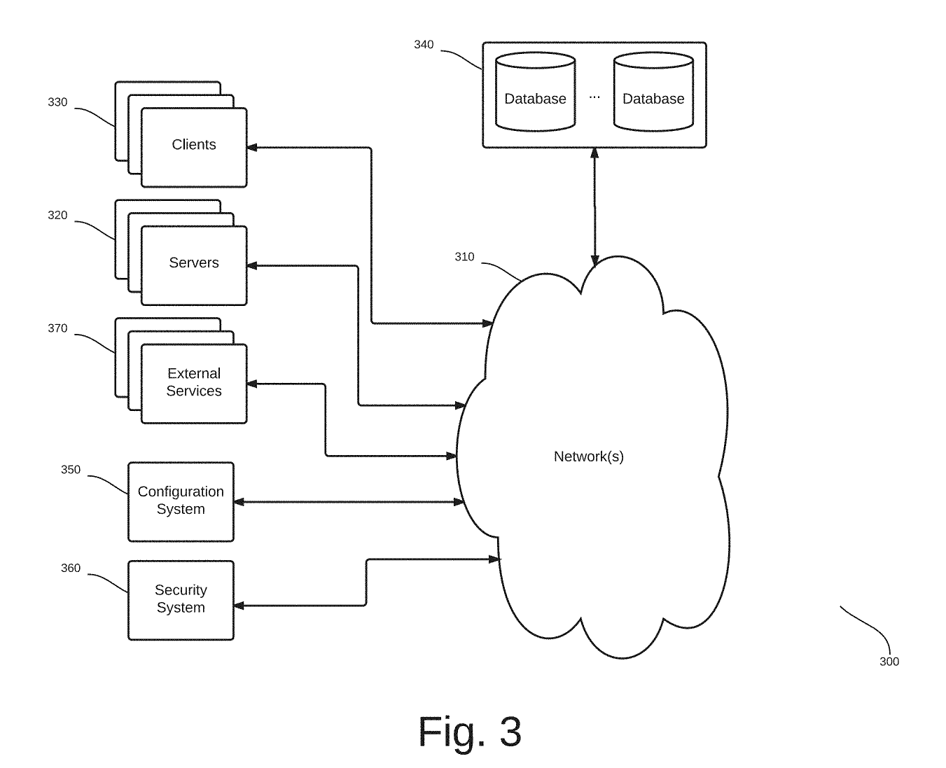

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

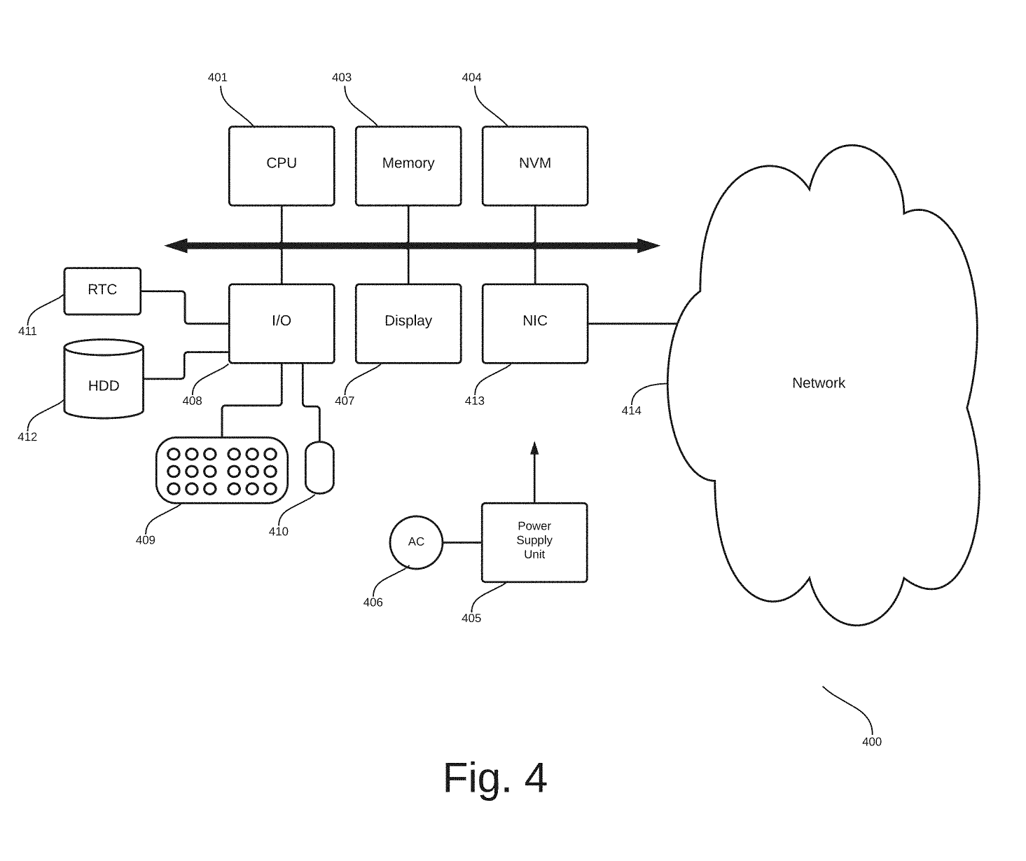

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

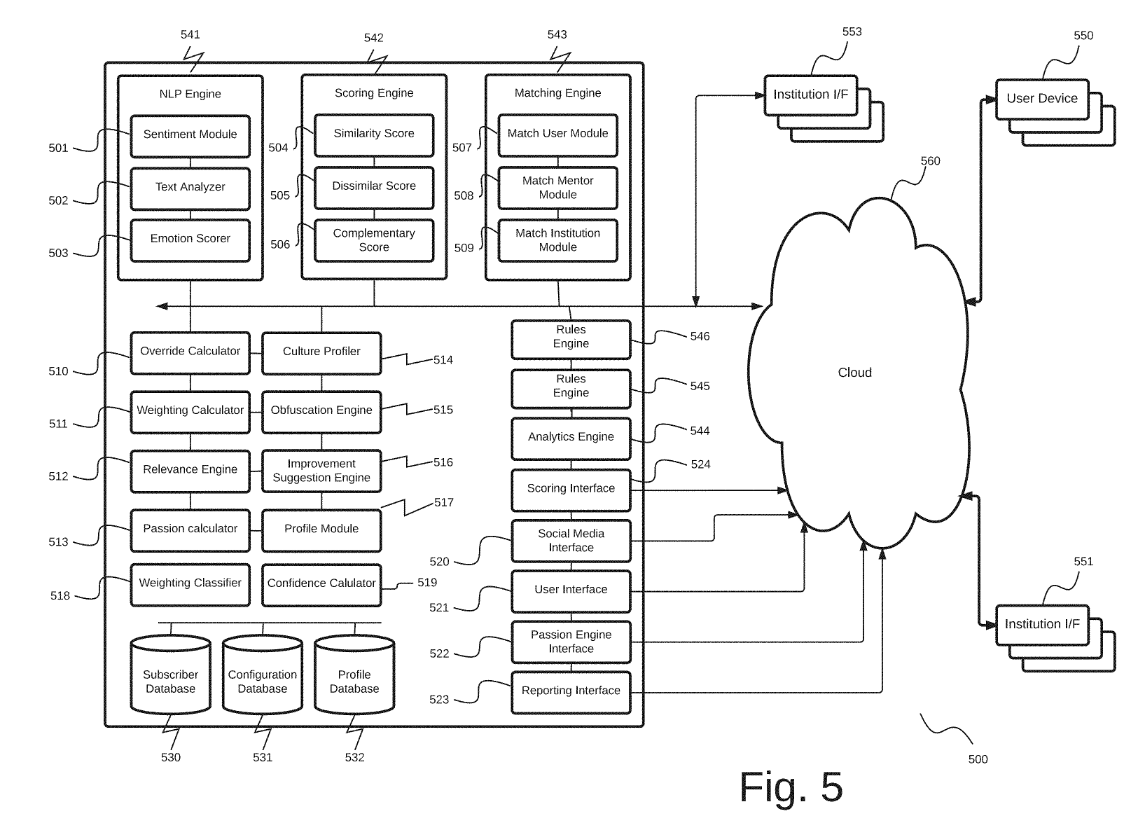

FIG. 5 is a block diagram of an exemplary system architecture 500 for enhanced user matching, according to a preferred embodiment of the invention. According to the embodiment, a variety of modular components may be used to incorporate and utilize data of varying nature or origin, and to process this data using scoring, matching, and analysis to drive a user matching operation based on at least a submitted profile by a plurality of users (for example, from known social media platforms such as Facebook™, Linkedln™), and registration to the instant invention, and the like, analyzed text from online sources (for example, marketing material, social media groups, timeline input, and the like), and input from a plurality of services (for example, survey results, questionnaires, and the like). It should be noted that the term “user” can apply to at least a human user such as a person operating a user device 550, for example a smartphone, computer or some other device to interface with system 500 interfacing to the system vis user interface 521), or to an institution (for example, and organization, club, educational institution, commercial establishment, and the like) using institution interface (“I/F”) 551 to interface over network 560 to at least user interface 521. In some embodiments institutions may interface directly to system 500 through institution I/F 553. Various data sources may be connected via software or hardware interfaces such as an institution interface 553 that may facilitate integration with various resources such as a corporate database (for example, to use a human resources database to connect users within an organization, information from educational establishments, such as areas of study, faculty, major, minor, etc.). In some embodiments, resources may also communicate via a network 560 such as the Internet or a local network such as a corporate network within an organization, optionally with the use of additional interfaces 551 to integrate with additional products or services via a cloud 560, for example to utilize an online database or third-party product provided in a software-as-a-service (SaaS) business model. A user device 550 may be used by a user to connect and interact with their particular information such as a user account or configured preferences (as described below), and may be any suitable network-connected computing device such as a personal computer or smartphone, according to a user's preference.

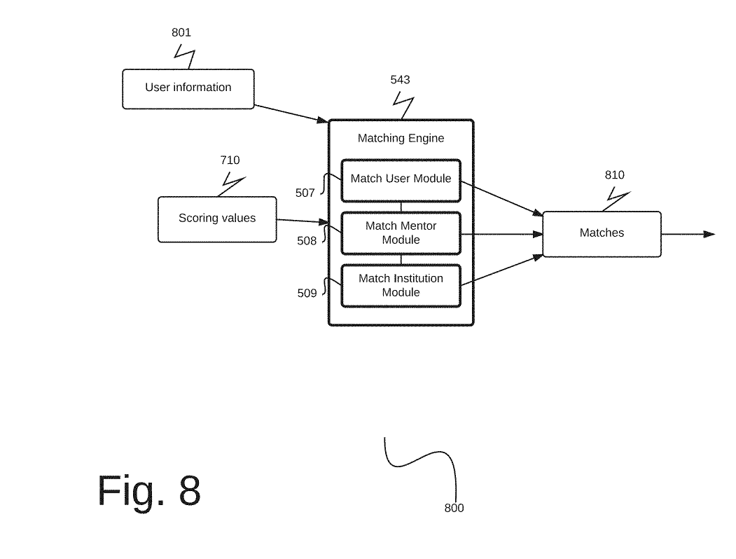

According to the embodiment, a natural language processing (NLP) engine 541 may be used to perform natural language processing including sentiment, emotion, text analysis with machine learning to continuously improve operation. For example, NLP may be used to produce career challenges using natural speech, as described below (referring to FIG. 8), or to receive and interpret natural language input from a user. It should be appreciated by one with ordinary skill in the art that a number of modern NLP algorithms, for example, based on machine learning, especially statistical machine learning, and the like. For example, a suitable NLP algorithm may take as input, a large set of “features' that are generated from input data for example, from decision trees to algorithms focused on statistical models, which may make soft, probabilistic decisions based on attaching real-valued weights to each input feature. Such models have the advantage that they can express the relative certainty of many different possible answers rather than only one, producing more reliable results. It should further be appreciated by one with ordinary skill in the art, that learning procedures used by NLP engine 541 may (1) automatically focus on a plurality of” most common cases”; (2) employ automatic learning procedures that may make use of statistical inference algorithms to produce models that are robust to unfamiliar input (for example, containing words or structures that have not been seen before) and to erroneous input (for example, with misspelled words or words accidentally omitted); (3) be based on automatically learning rules (for example, from rules engine 545) to increase accuracy by, for example, supplying more input data. In some embodiments, techniques known as Natural Language Learning (NLL) may be employed which may comprise computational linguistics and language acquisition algorithms to understand more about human language acquisition, or psycholinguistics from the various social media sources used in system 500. In a preferred embodiment, NLP engine 541 may implement a number of known functions known in the art, for example: (1) Automatic summarization to produce a readable summary of a plurality of text. For example, to provide summaries of text of a known type, such as articles from of a newspaper, or text in a blog of a known category. In some embodiments, a category is added after the automatic summarization. (2) Co-reference resolution to determine which words (“mentions”) may refer to objects, people, etc. (“entities”) from a given a sentence or larger portion of text. In some embodiments, anaphora resolution may be implemented for matching pronouns with the nouns or names that they may refer to. Tasks to form “bridging relationships” may be implemented for involving referring expressions. (3) Discourse analysis to identify a discourse structure of connected text, for example, to identify a nature of the discourse relationships between sentences, individual users, institutions, social media posts, newsfeeds, etc. for elaboration, explanation, or contrast, or a combination thereof. In some embodiments, discourse analysis may recognize and classify speech acts in a portion of text (for example, yes-no question, content question, statement, assertion, and the like). (4) Machine translation to automatically translate text from one human language or dialect to another. (5) Morphological segmentation to separate words into individual morphemes and identify classes of the morphemes. (6) Named entity recognition (NER) whereby given a stream of text (for example from a social media platform, text within a communication, information held in a user profile, and the like), to determine which items in the text may map to proper names, such as people or places, and what the type of each such name is (for example, person, location, organization, etc.. (7) Natural language generation to convert information from computer databases into readable human language. (8) Natural language understanding to convert portions of text into more formal representations such as first-order logic structures that may easier for other components in system 500 to manipulate to identify an intended semantic from multiple possible semantics which can be derived from a natural language expression which may usually take the form of organized notations of natural languages concepts. (9) Part-of-speech tagging whereby given a portion of text, determine a part-of-speech for each word. For example, to understand semantics around text from various sources when a word can be both a noun (for example, “the book on the table”) or a verb (“to book a flight”) to reduce or remove ambiguity. (10) Parsing to, for example, determine a parse tree for grammatical analysis of a given portion of text. (11) Question answering to identify questions within text, and determine an answer. (12) Relationship extraction for a portion of text, for example, to identify a relationship among named entities (e.g. familiar relationships, alumni relationship to an institution, and the like). (13) sentence boundary disambiguation for a portion of text to find the sentence boundaries. (14) Sentiment analysis, via subcomponent 501, to extract subjective information usually for a portion of text, often using to determine, for example, determine a “polarity” about specific objects. (15) Speech recognition to determine a textual representation of the speech from an audio or video conversation bot in real-time, or from pre-recorded conversations. (16) Speech segmentation to separate an audio or video clip of a person or people speaking, into words. (17) Topic identification and segmentation to separate a portion of text into segments whereby each word may be devoted to a topic, and identify a topic for a segment. (18) Word segmentation to separate a portion of continuous text into separate words. (19) Word sense disambiguation to select a most appropriate meaning which makes the most sense in context for words with multiple meanings.

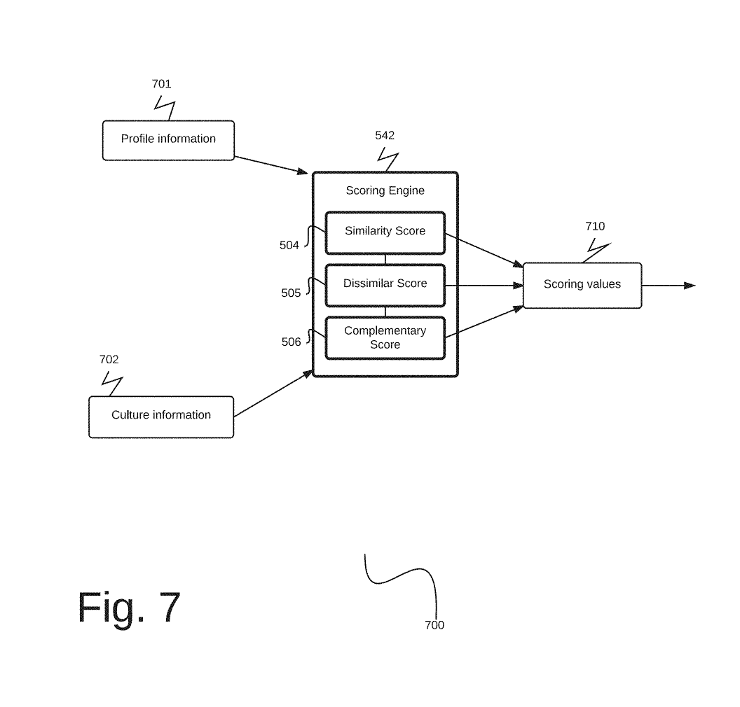

In a preferred embodiment, NLP engine 541 may use sentiment module 501 and text analyzer 502 to compute, for example, a true meaning of a user's desires, motivations, and aspirations. For example, a user may have previously entered certain information in a user profile, but NLP Engine 541 may indicate conflicting information, for example, a user may have indicated that they require marketing expertise for a business endeavor whereas, by reviewing comments made by the user (for example, as Blog comments or on a social media timeline), NLP Engine 541 may determine that the user lacks basic business planning skills and would conclude that the user would require some business planning assistance before marketing assistance. In this example, override calculator 510 may modify the matching approach and results. A sentiment module 501 may be used to monitor the sentiment of a plurality of conversations (text, video or audio) for users to determine sentiment for a plurality of matching variables, including, but not limited to, institutions, users, business goals, and the like. For example, for use in a matching operation (as described below, referring to FIG. 7). Text analyzer 502 may be used to analyze text, spots keywords, and may be used in weighting and automated classification operations. Emotion Scoring 530 may be used to process emotion in text, audio, and video transactions, for example to determine if a user is excited (i.e. likes the discourse), user is bored, or other such emotional analysis. Emotion scoring 530 may also weight a certain category of input as “more important” (or in some cases, “less important”) based on calculated emotion for the analyzed input. In this regard, weighting calculator 511 would append an appropriate weighting to the input.

According to a preferred embodiment, rules engine 545 stores a plurality of preconfigured matching rules in configurations database 531. Matching rules define at least how various components of system 500, including but not limited to, scoring engine 542, matching engine 543, analytics engine 544, NLP engine 541 will function in a given context, rules engine 545 may be customized in a preconfigured fashion or in real-time while matching occurs. In a preferred embodiment, scoring interface 524 receives results from matching from users and inputs the results to rules engine 545 in order to improve matching rules. Matching rules may include descriptions on how cultures interact, predefined values for determining when a user is considered a mentor, what may constitute a dissimilar scenario, and the like.

Scoring Engine 542 may be used to calculate scores and to utilize scores (for example, such as a university scoring from a magazine, an online influence score, such as a Klout™ score, for an individual, etc.) and score or sort other mentors, users, or institutions for various purposes. In this manner, a scoring engine may be used to drive analysis-based operation by processing received information to determine scores, and then using those scores to make operational decisions for use by, for example, a matching engine 543 to match users with other parties, or to group parties using score-based criteria such as to segment users based on similar preferences or roles within an organization or field. In some embodiments, scoring engine 542 may score categories of inputs based on a set of rules, for example, information analyzed that were categorized as marketing material would be scored low, that is, marketing material would hold a lower confidence in that the information analyzed by analytics engine 544, would be held in less regard than, for example, an alumni group discussion which may account for a more accurate account of the topic discussed. In this regard, weighting calculator 511 would assign a higher score to the alumni group discussion that it would for the marketing material. In some embodiments, relevance engine 512 may correlate the relevance of an analyzed input to the matching goal. A similarity score 504 may show how similar scoring participants are, for example to aid in grouping and organizing parties as described previously. For example, if two matching subjects have similar skills (for example, institutions with similar offerings, individuals with similar professional skills, etc.) or in other embodiments, similarity score 504 may score similar needs concurrently (for example, an individual with marketing expertise who may need R&D skills may be matched with an individual with R&D skills who requires marketing advise, or resource or academic needs, for example a student may need notes from a class they missed, they would like help with a certain subject or class, and need to be matched with another user whose profile indicates a higher skill, and the like). In some embodiments, override calculator 510 may override a similarity score for a number of reason, for example, the individuals or institutions have been matched before and a dissatisfactory resulted. Dissimilar score 505 may be used to negate matches, for example based on social, geographic, or other aspects. For example, on a religious or political spectrum, individuals whose heritage is from opposite sides in a current or recent conflict zone, for example in known conflict zones as analyzed from the media (or any other such conflict that may have lasting sentiment implications, for example nonviolent conflict such as investment or development opportunities), or other conflicting interests that may be used to intelligently preclude a match that may otherwise appear favorable. In some embodiments, dissimilar score 505 may negate a match based on individuals working for competitors, or where it may have been determined that, for example, an employment contract may be in conflict with such a matching. In this regard, the matched individual score would be put low as directed by dissimilar score 505. Complementary score 506 may be used to identify where complementary skills could imply a beneficial relationship, for example to identify a potential match between an engineer or entrepreneur and a marketing professional. In some embodiments, a match based on, for example, a calculation by complementary score 506 may be initiated without a user's specific instruction. In this regard, a series of “suggested matchings” may be included within a primary matching, or may be separate all together.

A matching engine 543 may be used to match individuals, institutions, projects, and other entities based on various data sources (for example, based at least in part on scoring information from a scoring engine 542, described previously). In some embodiments, a proactive match (that is, a match not requested or initiated by a user), may match a user with specific skills to a project requiring those skills. In this regard, scoring engine 542 may perform a necessary scoring to suggest projects to users and vice versa. In some embodiment, match user module 507 may match users to each other (peer matching), for example based on shared interests, similar fields of expertise, or similar goals (for example, career goals, professional goals, project goals, etc.). Match mentor module 508 may match mentors to other mentors (for example, for collaboration) or mentors to mentees (for example, matching a mentor to a user to assist them with making a career decision or overcoming a particular challenge). In some embodiments, NLP engine 541 may proactively identify mentors based on various metrics and pre-defined rules. For example, if a user's comments have been analyzed by analytics engine 544 through social media interface 520, and, for example, it has been identified that the user may have, for example, commented a predefined number of times on a predefined number of blogs in their identified area of expertise, and if text analysis 502 in conjunction with sentiment module 501 determine that the comments represent highly skilled commentary, the user may be identified and flagged as, for example, a mentor. In some embodiments, this user may be invited to become a mentor on system 500. In some embodiment, match institution module 509 may match institutions (for example, a college, social group, club, corporation, meet-ups, or other such collective entity) to users or other institutions. In this manner, various parties may be matched with one another based on received information from various sources and optionally incorporating scoring information from a scoring engine 542, described previously.

Override calculator 510 may be used to produce a plurality of override calculations, that may be used to override information from user profile, scoring information (for example, a university review in TIME™ magazine) or information provided by a user or marketing information. For example, after receiving a plurality of information or scoring information (or both) from various sources, information may be weighted by weighting calculator 511 and an override calculation produced by override calculator 510, to, for example, determine which information should be utilized or whether a match should be considered “valid” (for example, based at least in part on a dissimilarity score 505 as described previously). A weighting calculator 511 may be used to assign a weighted value to various types of information (for example, emotion detection for a monotone speaker from ASR would be weighted low while emotion detection based on level of profanity in a speaker via ASR would be weighted high). Weighting may also be used with different sources of information (whether calculated or entered by a user), for example to determine whether a particular source has an overall lower value than another source. Weighting may also depend on source, for example information from an alumni group may be weighted higher than marketing information from the institution, or other arrangements that may use weight to, for example, counteract apparent bias between sources.

A relevance engine 512 may be used to calculate a score to assign a relevance to a piece of information (for example, an engineering student looking for R&D matching would not be matched to a marketing R&D student). According to another example, scoring of an institution known to associate with a conflicting political party would hold little relevance. Conversely, an engineering student looking for entrepreneurial mentorship may be matched with a marketing professional, based on a determination that marketing may be of greater relevance to the user's particular goals. Passion calculator 513 may use ASR, text, sentiment, emotion to determine a passion score, to determine how passionate a user is with respect to a certain subject, mentor, institution, or other information or entity. Passion calculator may use a combination of information from, at least, sentiment module 501 and emotion scorer 503 to calculate and weight for strength, passion and reach within a portion of text. In some embodiments, passion calculator 513 may receive a passion score from systems known in the art to provide passion scores (or the like). Culture profiler 514 may profile cultures of institutions (such as a workplace or university) and a desired culture for a user. Culture profile may provide information useful to scoring individuals, institutions, projects, etc. In some embodiments, culture profiler 514, may actually determine the culture of an entity (i.e. individual, institution, project, etc.) for example, a university that is known to have a particular political or religious affiliation; for example, a project that is made up of mostly male members may indicate a particular culture. Analytics engine 544 may use this information (whether calculated or received) to use to interface with at least scoring engine 542 and matching engine 543 to perform matching (as described herein). Obfuscation engine 515 may be used to remove customer identifying information so that the data can be exported for use in external analytics, advertising, or other purposes, alleviating privacy concerns for users. Improvement suggestion engine 516 may be used to perform machine-learning and identify areas for improvement, for example if a score is low for a user in a particular classification (where a determined improvement may comprise offering advice to a user to improve their performance or appeal in a certain area, or altering analysis or matching to avoid problem areas and focus on a user's strengths). Improvement suggestion engine 516 may calculate a hypothetical score for a particular matching, wherein a score is based on an assumption that a certain skill had been available (or higher, alternate value, or other variations). Such functionality may be used to suggest various ways for users to get better matches (for example, to be matched with higher profile individuals or institutions, etc.), or to reach certain goals (for example, to become a mentor, etc.), providing insights for personal improvement. Profile module 517 performs profile tasks such as associating particular portions of information with particular users, for example to produce a persistent “user state” comprising a user's various information, scoring, matches, or other data that may be stored and retrieved for future reference (such as in a profile database 532, as described below), as well as processing retrieved user profile information and providing portions of the information to other modules for additional processing (for example, identifying user sentiment pertaining to a particular organization and providing this information to a scoring engine 542 for incorporation in scoring operation).

Subscriber database 530 may be used to, at least, store and provide subscriber information, such as participating users and organizations. Configuration database 531 may be used to hold, at least, system configuration data, such as user preferences and operation configuration information (for example, particular information for use with interfaces 551, 553 to facilitate integration with third-party products or services). Profile database 532 may be used to hold, at least, user, institution, or other entity profiles. Profile database 532 may also be used to store and provide, at least, profiles retrieved from other social media profiles retrieved through social media interface 520, for example, profile information from Facebook™, Linkedln™ Angel List™, and other social networks.

Social media interface 520 may be used to operate a variety of software interfaces to integrate with various social media networks and third-party services, for example Linkedln™ Facebook™, or other social networking products or services. Social media interface 520 may receive a variety of social network information, for example social metrics such as “likes” or “dislikes”, and may be used to perform sentiment or emotion analysis for discourse on other platforms. In a preferred embodiment, social media Interface 520 may be used to analyze comments on a social media timeline (for example Facebook™ timeline, Linkedln™ posts, Linkedln™ group or pulse posts, Tweets on Twitter™). In a preferred embodiment, social media Interface 520, may interface to social media monitoring application (for example eCairn™ Salesforce™ Marketing Cloud, Radian 6™, Hootsuite™, Klout™, or other RSS feed readers). User interface 521 may operate, send, and receive information to and from a variety of software interfaces configured for user interaction, for example a graphical user interface for presentation and interaction within a software application operating on a user's device 550. Reporting Interface 523 may be used to produce and provide reports to allow advertisers, institutions, or other entities to review data such as operational logs or reports from specific operations (optionally including obfuscated data, obfuscated by obfuscation engine 515, such as anonymized user account details, and the like). Scoring Interface 524 may be used to retrieve scoring information from existing sources (for example, a physical or virtual magazine or publication, or an online service such as Survey Monkey™), for use in place of or in addition to scoring information produced by a scoring engine 542.

Analytics engine 544 may be used to perform a variety of analysis tasks, incorporating various arrangements of information such as user data and scoring information from various sources. For example, information pertaining to a plurality of corporations or other institutions may be analyzed for culture information to be passed to a culture profiler 514, which may then process culture information and provide results to a scoring engine 542 for use in producing a plurality of scoring values for the institutions, which may then be used by a matching engine 543 to match the institutions with other entities. In this manner, it may be appreciated that analysis engine 544 may operate in conjunction with various other modules of a user matching system 500 to drive analytics and intelligent operation for enhanced matching utilizing information of varying nature and from a wide variety of sources. Additionally, information that may not have a corresponding processing module (for example, in arrangements that omit some modules) may be processed by an analytics engine 544 to provide a form of analysis fallback, providing functionality despite the omission of specialized processing component. Additionally, information that has been processed by specialized components (such as user-provided text processed by an NLP engine 541) may be further analyzed by analytics engine 544 to derive additional insights, and those insights may then optionally be provided to a matching engine for inclusion in matching determinations, or presented to some or all connected interfaces for inclusion in external applications or presentation to a user. In some embodiments, analytics engine 544 analyzes transactions, matching, communications, reason codes, mediums of exchange, etc. for analysis of system usage.

In some embodiments, analytics engine 544 may operate in part as an automated speech recognition (ASR) module and may be used to perform automatic speech recognition, for example to spot keywords in audio conversations (or audio portions of video conversations), and may provide recognized speech information to an NLP engine 541 for use in language processing. In some embodiments, analytics engine 544 may operate in part as facial recognition module to gather sentiment or emotion information from facial expressions or other visual indicators in images or video, for example during a video conference call, reviewing video footage from newscasts or company presentations, or from images obtained through social media or other sources. An automatic classifier 546 may be used to classify conversations and other data elements based on calculated classification values (for example, sentiment, emotion, or passion) or scoring information (versus what the user inputted in the profile). Automatic classifier 546 may be used in conjunction with an override calculator 510, to incorporate override information in classification operations or to provide classification information for use in determining override values. A weighting classifier 518 may be used to form contextual classifications of information, for example based on information from a weighting calculator 511. Confidence calculator 519 may calculate a confidence score when overriding or providing conflicting scores, for example “likes” based on text analysis from a social network, as opposed to what a user may have included in their profile. Confidence scoring information may be used when making weight determinations using a weighting calculator 511 or a weighting classifier 518, so that confidence may be considered when weighing information sources.

### Detailed Description of Exemplary Embodiments

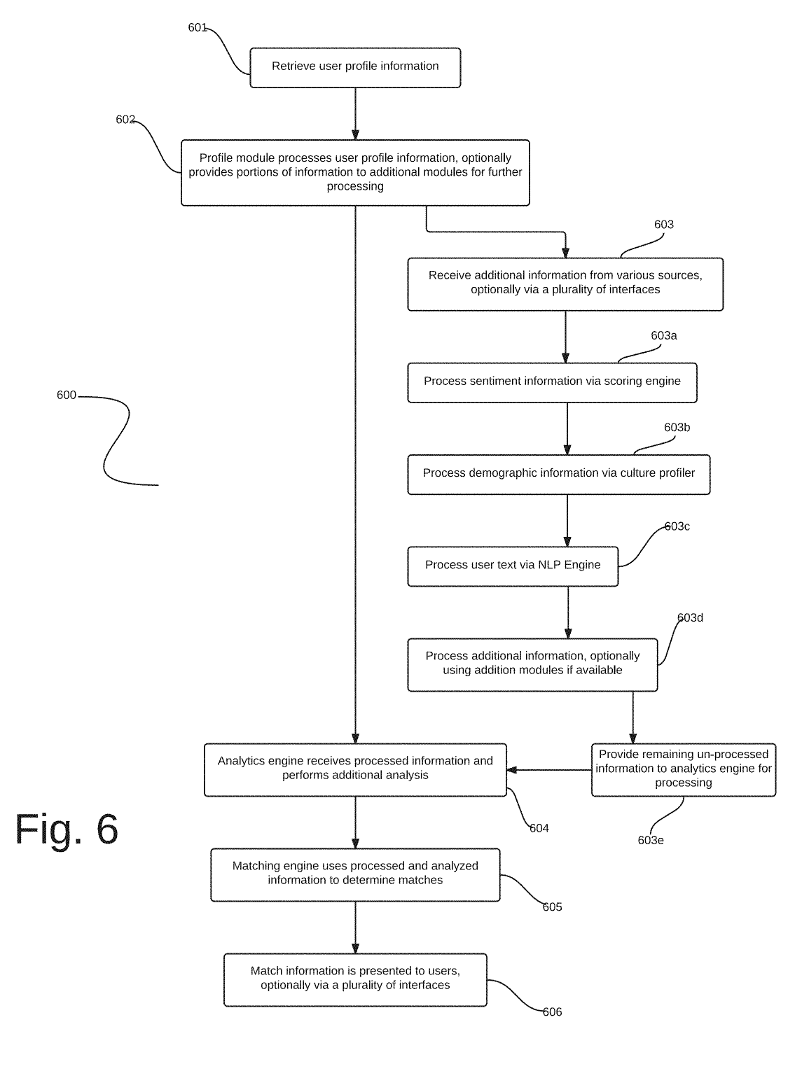

FIG. 6 is a flow diagram illustrating an exemplary method 600 for enhanced user matching, according to a preferred embodiment of the invention. According to the embodiment, in a first step 601 a user's profile information may be retrieved, for example from a profile database or other data storage. In a next step 602 the profile information may be processed by a profile module, and portions of information may be identified and provided to respective processing modules for further processing. In a next step 603, additional information may be received or requested from additional connected resources such as social networks or data stores, optionally utilizing a variety of software or hardware interfaces according to a particular arrangement or use case.

In a first processing step 603a, user-provided sentiment information such as religious, political or other affiliations (for example, sports teams or universities) may be provided to a scoring engine for further processing. In a next processing step 603b, a user's demographic information (such as gender, ethnic background, geographic location, or other demographic identifiers) may be provided to a culture profiler for further processing, and in a next processing step 603c any user-provided text may be provided to an NLP engine 541 for additional processing. In a further processing step 603d, any remaining information may be processed and provided to additional processing modules, if available, and if no appropriate modules are available remaining information may optionally be provided to an analytics engine for further processing in an optional sub step 603e.

In a next step 604, processed information may be received from specialized processing modules (for example, an NLP engine 541 or culture profiler 514, or any other modules or combinations of modules according to a particular arrangement) and may be optionally provided to analytics engine 544 to derive any further data insights. In a next step 605, information from all sources may be processed by a matching engine 543, generally to match a user with additional users, organizations, or other entities. Resultant matching information may then be provided to a user in a next step 606, optionally via one or more software or hardware interfaces according to a particular arrangement or use case. In this manner, it can be appreciated that information may be collected from various sources, processed using specialized system components where possible according to a particular arrangement, processed using an analytics engine, and then used to match users with other entities such as users, industry experts, career counselors, tutors or mentors, or organizations such as corporations or groups that may be interested in the user. Such operation may be used to assist users in, for example, overcoming career challenges by connecting them with other users that are particularly skilled in assisting with their specific issues or needs, as well as helping users with, for example career or business path decisions by identifying possible leads and options for exploration based on their specific information.

FIG. 7 is a block diagram illustrating a more detailed view of a scoring engine 542 and scoring logic. According to the embodiment, a scoring engine 542 may receive a variety of information pertaining to users, organizations, or other entities, and may generally process this information to determine a plurality of scoring values to be used in matching entities with each other. For example, user profile information 701 may be received from a number of user profiles (each of which may represent an individual, organization, or other registered entity), and may be processed to determine a plurality of similarity score values 504, generally representing the degree of similarity between profiles, such as by identifying shared interests or qualifications. Additionally, information may be processed to determine a plurality of dissimilarity score values 505, representing a degree of difference between profiles, such as conflicting interests or different views on key topics such as political views. Additionally, profile information 701 may be processed to identify a plurality of complementary scores 506, generally corresponding to identified correlations between profiles such as to match professionals based on their qualifications with others who may be of particular use or interest to them based on their goals or needs, or to match a user with an organization that values a skill they excel at or has a need for a skill they offer.

Further according to the embodiment, a plurality of culture information 702 may be received by a scoring engine 542 for processing, and may be processed to determine similarity 504, dissimilarity 505, or complementary 506 scoring values based on, for example, identified cultural information between users, profiles, or information sources. For example, a social network may cater specifically to users with certain cultural values such as ethnic background or political views, and may then be correlated with a user who has appropriate cultural values but is not yet a member. In another example, two users may be matched based on shared cultural information such as religion, whereas otherwise they may not have any readily-recognized correlations due to differing interests, abilities, or goals. In this manner, cultural and demographic information may be used to aid users in matching operations, increasing the personal relevance of results and helping users to connect with one another and begin a relationship with a degree of similarity that may facilitate greater collaboration and benefit for both involved parties.

Further according to the embodiment, scoring values may be provided as data output 710 for further use, such as by analytics engine 544 to perform additional processing or for incorporation by an override calculator to determine whether to utilize or override particular scoring values, or other such further processing.

FIG. 8 is a block diagram illustrating a more detailed view of a matching engine 543 and matching logic. According to the embodiment, user information 801 may be received and utilized, such as user-provided information (for example, responses to prompts or questions, such as via a software interface with which a user is interacting) or information retrieved from a stored user profile. Additionally, scoring information 710 may be received, generally as provided by a scoring engine as output data after processing a variety of source information and determining scoring values. This information may be processed by a variety of matching modules to identify and present matches between various entities, for example a user match module 507 may match users with one another based on (for example) similar scoring values in key areas (such as experience within a particular field, or shared personal interests or goals, or identified skill correlations). A mentor match module 508 may match users with mentors, or mentors with each other, generally to assist in facilitating a mentorship relationship to help users overcome particular challenges or achieve specific goals, or to help mentors collaborate with one another such as to advance in their own fields (thereby increasing their value as mentors, as well as assisting them with any user-oriented needs they may have themselves). An institution match module 509 may then be used to match institutions (such as corporations or other organizations or collective entities) with users (such as to identify prospective employees), mentors (such as to identify mentors whose assistance may be useful for a corporation's staff, or who may themselves be valuable additions to staff), or other institutions (such as to identify organizations with shared interests and complementary abilities, for example to assist in forming a business partnership to benefit both parties). Resultant matches may be provided as data output 810 for further use, such as for processing by analytics engine 544 to identify any further insights, or for presentation to a user.

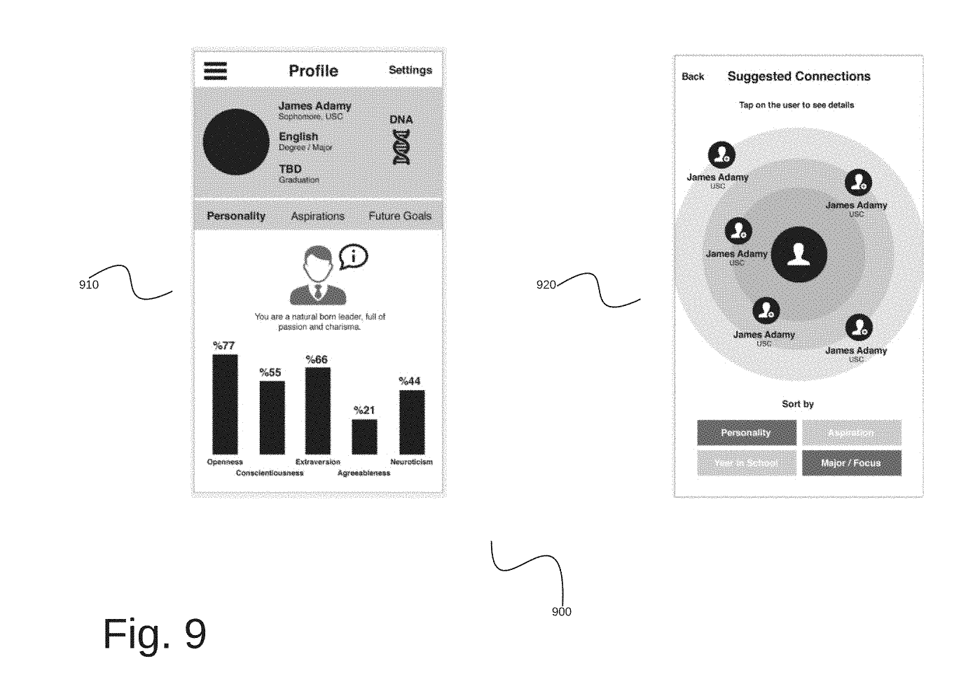

FIG. 9 is an illustration of an exemplary user interface 900 for a mobile application operating on a smartphone, illustrating a preliminary user configuration 910 and a home screen 920 overview. A user may be prompted for a plurality of voluntary and anonymous data at enrollment and calibrate it with a member's initial challenge to begin identifying other members and vetted advisors that can provide quick solutions. Preliminary factors that may be utilized to introduce others with solutions may include (for example, and not limited to):
Industry
Role/title
Gender
Location
Challenge/Aspiration
Psychometric & values information

Challenges may be presented in natural language (utilizing an NLP engine 541, as described above referring to FIG. 5) and may be restricted in length (for example, to fit a device screen or to promote user engagement by not making challenge text prohibitively lengthy). A combination of automated screening and manual approval may be used before a challenge is released to a network to maintain a high level of integrity and to eliminate complaints against individuals and companies. Exemplary challenges may include, but are not limited to:
If I can sell 28% more this quarter, I'll be able to buy a pool for my family!
Just got promoted to Sr. Director . . . Feeling overwhelmed!
Big presentation with the CEO next week. Terrified!
I've been with my company for four years and still haven't received a raise.

Once a member has completed their anonymous profile, they're brought to the home screen which illuminates only the most relevant and current content available to help them leap ahead from four streams: relevant news & information (“Trending”); peers, advisors, mentors and recruiters (“Network”); discussions of interest (“Community”); and local and online activity (“Events”).

A home screen layout may place a user at the center of their career track in a visualization model, and surround them with personalized and filtered content that serves as a one-swipe process to frequently interact with a career matching system.

Home screens can change in real-time based upon new content available on the network and machine learning generates new results that are optimized for each member. Periodic push messaging to email is used to bring users back to the app frequently and a system tray alert will be available as an option on mobile platforms. The home screen also leads members directly to solution providers—like-minded peers and vetted advisors available to deliver proven tactics that help resolve member challenges.

Users can choose a variety of options from the home screen but many will quickly want to explore community lounges, where challenges are presented and tailored solutions provided. Lounges are sponsored by corporate brands that have no editorial control over the lounge.

Lounges enable the collection of additional user behavior and content for machine learning. User behavior may be tracked across a network and used to build a profile that assists in understanding how to best provide tailored solutions. Until a user elects to reveal their identity they may be assigned a random number/digit sequence or another anonymous identifier.

Identities can selectively be revealed in lounges, to advisors, 1:1 with another user, or to the entire network.

Meet-ups, events and conferences taking place across the country may be tracked and injected into each member's user experience based on their location, behavior, interests and preference. Helping users make new connections and finding relevant activity may be used to extend impact beyond just an app encounter.

Whenever a solution, activity or news item is presented to a user, they may be asked if the content was helpful. These “thumbs up” or “thumbs down” responses may be used to train a career matching system and tailor the delivery of news, recommendations, solutions, advisor introductions and potential users of interest.

Personalized recommendations may be presented to each user based on a number of variables (member ratings, specialty, location, number of engagements, number of comments posted in lounges, etc.) that may be calculated to eliminate unqualified advisors.

Mentors may be presented to users through a screen layout that shows those with the highest probability of delivering a solution in closest proximity to the member as an anonymous individual, for example based on data provided by scoring or matching engines.

Users can view mentors, but their personal identification information is obfuscated until they elect to reveal their identity. Mentors promote themselves by participating in lounge discussions, responding to individual challenges, posting videos, hosting webinars and generating content (white papers, blog-style articles, infographics, slide decks and presentations) that becomes part of the network and becomes elements of member discovery as they solve particular challenges.

If a mentor is appealing to a member, they can reach out and initiate a conversation that leads to a private chat, phone or live video meeting. Interactions between members and mentors are totally private and excluded from any exposure on the network, except for member-provided advisor ratings. Mentors may define their own service offering and pricing, for example from the following exemplary menu:
1:1 call for (fixed price or price per minute)
1:1 video conference (fixed price or price per minute)
Pay per view video
Pay per attend webinar
Pay per download document

Mentors may share a percentage of revenue generated from networking. Billing may be processed and relationships are channeled through the network as a means of protecting members, similar to the way that freelance services like UPWORK™, GLG™, Guru.com™, and the like, to create a continuum of in-network commerce.

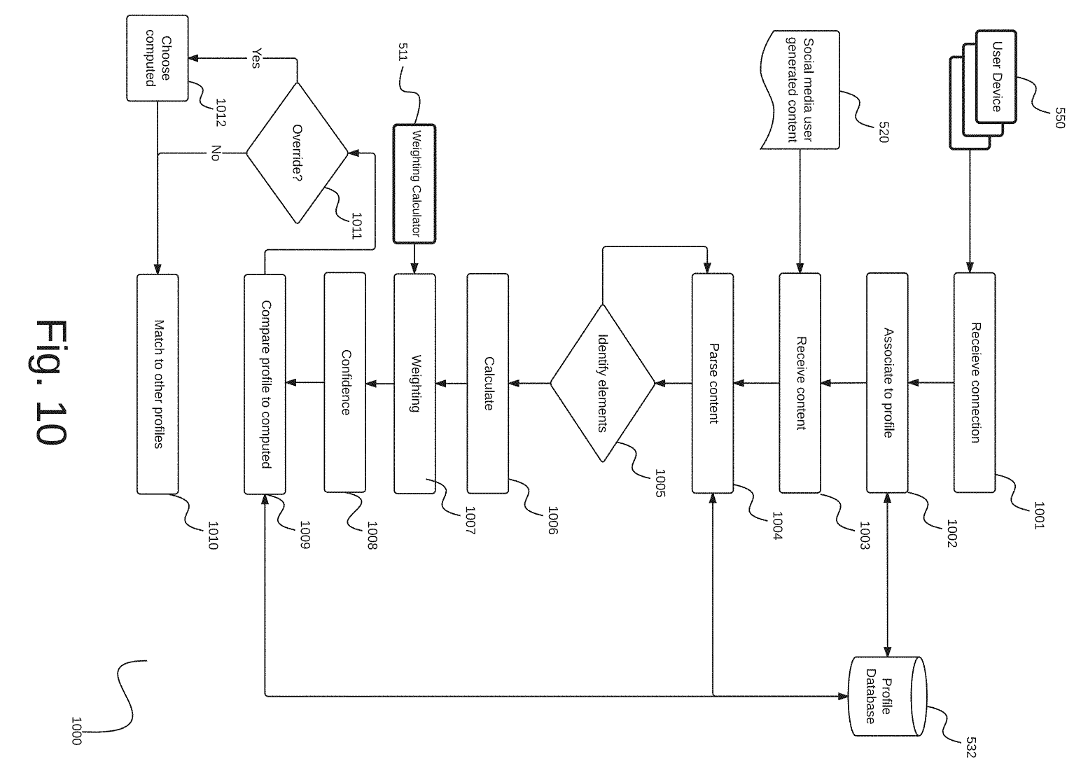

FIG. 10 is an exemplary flow diagram illustrating a method for overriding calculated elements with profile elements, according to a preferred embodiment of the invention. According to the embodiment, method 1000 comprises a network-connected user profile matching computer comprising at least memory 240 and processor 210 and further comprising programmable instructions stored in memory 240 and operating on processor 210, the instructions configured to match a plurality of user profiles in an online communication environment comprising, in a first step 1001, receiving, a plurality of connections from a plurality of user devices 550. In a next step 1002, associating, at profile database 532, the plurality of user devices 550 to a plurality of user profiles stored in profile database 532. In a next step 1003, receiving, at social media interface 520, a plurality of user-generated content, the plurality of user-generated content associated to the plurality of user profiles stored in profile database 532. The plurality of user generates content is then parsed in step 1004 to identify, at a first user profile, a plurality of elements, and, at least, one profile goal. More elements are parsed in step 1005 until no more elements are defined or based on some other pre-configuration. In step 1006, NLP engine 542, then computes a computed goal based on an analysis if the user generated content (for example, a desire that may be evident from what content provided by an associated user device 550, such as certain business or personal desires, or identification of certain problems whereby a solution is being sought, and the like). The computed goal (and other identified elements may then be stored to profile database 532, by the NLP engine 542. In a next step 1007, a weighting of the elements (for example an identified goal) is performed by weighting calculator 511, for example, the identify the relevant importance of goals based on emotion, sentiment, passion scores (and the like) as described previously (i.e., as calculated by 501, 502, and 502. In some embodiments, weighting may happen based on predefined rules stored in the at least one computed goal and the at least one profile goal based on a plurality of pre-defined rules as defined in rules engine 546. In some embodiments a confidence level may be computed by confidence calculator 519, in step 1008, and associated to weightings to identify a level of confidence to convey a perceived accuracy level of the weighting. In a next step, 1009, override calculator 510 compares elements, including but not limited to, the profile goal, and the calculated goal along with associated weightings and confidence levels and decides a primary goal. That is, override calculator, in step 1011, may override the profile goal based on the relative weighting and confidence level of the calculated goal and choose the computed goal in step 1012. In some embodiments, rules engine 546 may utilize a context for matching a plurality of other users of the plurality of user profiles to the first user, whereby the context is based on at least the weighted at least one computed goal and the weighted at least one profile goal. In a next step 1010, matching engine 543 may match the weighted plurality of other user profiles to the first user profile based on, at least, the context information;

In some embodiments, scoring engine 542 may score the plurality of user-generated content and the plurality of other users for relevancy based on, at least, the context information.

In some embodiments, scoring engine 542 may rank the plurality of other users based, at least in part, on scores of the plurality of user-generated content and the scores of the plurality of other users.

In some embodiments, a computed goal may be calculated using at least one or more user surveys associated to a first user profile.

In some embodiments, a context may be identified when the first user profile is associated to a mentor based at least in part on analysis of a plurality of user-generated content associated to the first user profile. That is the parsing of the user generated context identified the associated user profile as a mentor.

In some embodiments, user profiles may be associated to a plurality of institutions.

In some embodiments, user profiles may be associated to a plurality of educational institutions.

In some embodiments, user profiles may be associated to a plurality of corporations.

The skilled person will be aware of a range of possible modifications of the various embodiments described above. Accordingly, the present invention is defined by the claims and their equivalents.

What is claimed is:

1. A system for enhanced user profile matching comprising:
a network-connected user profile matching computer comprising at least a memory and a processor and further comprising programmable instructions stored in the memory and operating on the processor, the instructions configured to match a plurality of user profiles in an online communication environment comprising:
a plurality of connections from a plurality of user devices;
a social media interface;
a profile database;
a rules engine;
a weighting calculator;
a matching engine;
a scoring engine;
an NLP engine;
an override calculator;
wherein the plurality of user devices are associated to the plurality of user profiles stored in the profile database;
wherein a plurality of user-generated content is retrieved via the social media interface, the plurality of user-generated content associated to the plurality of user profiles;
wherein a first user profile comprises at least one profile goal;
wherein the NLP engine processes a plurality of user-generated content associated to the first user profile to determine at least one computed goal, further wherein the NLP engine associates the at least one computed goal to the first user profile;
wherein the override calculator compares the at least one computed goal and the at least one profile goal and weights the at least one computed goal and the at least one profile goal based on a plurality of pre-defined rules defined in the rules engine,
wherein the rules engine defines a context for matching the plurality of other users to the first user, the context based on at least the weighted at least one computed goal and the weighted at least one profile goal;
wherein the weighting calculator weights the plurality of user-generated content and a plurality of other user profiles of the plurality of user profiles, the plurality of other user profiles not including the first user profile;
wherein the matching engine matches the weighted plurality of other user profiles to the first user profile based on, at least, the context information;
wherein the scoring engine scores the plurality of user-generated content and the plurality of other users for relevancy based on, at least, the context information, further wherein the scoring engine ranks the plurality of other users based, at least in part, on the scores of the plurality of user-generated content and the plurality of other users.

2. The system of claim 1, wherein the at least one computed goal is calculated using at least one or more user surveys associated to the first user profile.

3. The system of claim 1, wherein the context identifies if the first user profile is associated to a mentor based at least in part on analysis of a plurality of user-generated content associated to the first user profile.

4. The system of claim 1, further comprising a confidence calculator, wherein the confidence calculator assigns a confidence level to at least one weighted computed goal.

5. The system of claim 1, wherein at least a portion of the other user profiles correspond to a plurality of institutions.

6. The system of claim 5, wherein the plurality of institutions are associated to a plurality of educational institutions.

7. The system of claim 5, wherein the plurality of institutions are associated to a plurality of corporations.

8. The system of claim 1, wherein the matching engine comprises:
a match user module;
a match mentor module;
match institution module;
wherein the match user module matches user profiles associated to individuals;
wherein the match mentor module matches, at least in part, user profiles identified as mentors;
wherein the match institution module matches, at least in part, user profiles configured as institutions.

9. The system of claim 1, wherein the NLP engine comprises:
a text analyzer;
a sentiment module;
an emotion scorer;
wherein the text analyzer parses text from the plurality of user-generated content;
wherein the sentiment module determines a sentiment score for the parsed text;
wherein the emotion scorer determines an emotion score for the parsed text.

10. The system of claim 9, further comprising a passion calculator, wherein a passion score is calculated based at least in part on the sentiment score or the emotion score or both.

11. A method for enhanced user profile matching comprising:
a network-connected user profile matching computer comprising at least a memory and a processor and further comprising programmable instructions stored in the memory and operating on the processor, the instructions configured to match a plurality of user profiles in an online communication environment comprising the steps of:
receiving, at a user interface, a plurality of connections from a plurality of user devices;
associating, at a profile database, the plurality of user devices are associated to the plurality of user profiles stored in the profile database;
receiving, at a social media interface, a plurality of user-generated content, the plurality of user-generated content associated to the plurality of user profiles;
identifying, at a first user profile, at least one profile goal;
processing, at an NLP engine, a plurality of user-generated content associated to the first user profile to determine at least one computed goal,
associating, by the NLP engine, the at least one computed goal to the first user profile;
comparing, at an override calculator, the at least one computed goal to the at least one profile goal;
weighting, at a weighting calculator, the at least one computed goal and the at least one profile goal based on a plurality of pre-defined rules defined in a rules engine,
defining, at a rules engine, a context for matching a plurality of other users of the plurality of user profiles to the first user, the context based on at least the weighted at least one computed goal and the weighted at least one profile goal;
weighting, at the weighting calculator, the plurality of user-generated content and the plurality of other user profiles, the plurality of other user profiles not including the first user profile;
matching, at a matching engine, the weighted plurality of other user profiles to the first user profile based on, at least, the context information;
scoring, at a scoring engine, the plurality of user-generated content and the plurality of other users for relevancy based on, at least, the context information;
ranking, at the scoring engine, the plurality of other users based, at least in part, on the scores of the plurality of user-generated content and the scores of the plurality of other users.

12. The method of claim 11, wherein the at least one computed goal is calculated using at least one or more user surveys associated to the first user profile.

13. The method of claim 11, wherein the context identifies if the first user profile is associated to a mentor based at least in part on analysis of a plurality of user-generated content associated to the first user profile.

14. The method of claim 11, further comprising the step of:
assigning, at a confidence calculator, a confidence level to at least one weighted computed goal.

15. The method of claim 11, wherein at least a portion of the other user profiles correspond to a plurality of institutions.

16. The method of claim 15, wherein the plurality of institutions are associated to a plurality of educational institutions.

17. The method of claim 15, wherein the plurality of institutions are associated to a plurality of corporations.

18. The method of claim 11, further comprising the steps of:
matching, at a match user module, user profiles associated to individuals;
matching, at a match mentor module, at least in part, user profiles identified as mentors;
matching, at a match institution module, user profiles configured as institutions.

19. The method of claim 11, further comprising the steps of:
parsing, at a text analyzer, text from the plurality of user-generated content;
determining, at a sentiment module, a sentiment score for the parsed text;
determining, at an emotion scorer, an emotion score for the parsed text.

20. The method of claim 19, further comprising the step of calculating, at a passion calculator, a passion score based at least in part on the sentiment score or the emotion score or both.
